(19) United States
(12) Patent Application Publication
(10) Pub. No.: US 2011/0126686 A1
(43) Pub. Date: Jun. 2, 2011

(54) MACHINE TOOL, MACHINE TOOL APPARATUS AND METHOD FOR OPERATING A MACHINE TOOL APPARATUS

(76) Inventor: Manfred Geiss, Sesslach (DE)

(21) Appl. No.: 12/712,471

(22) Filed: Feb. 25, 2010

(30) Foreign Application Priority Data
Nov. 30, 2009 (EP) 09177534.6
Nov. 30, 2009 (EP) 09177535.3

(51) Int. Cl. B26D 1/12

(52) U.S. Cl. 83/663

(57) ABSTRACT

The present invention provides a machine tool, comprising a permanent-magnet motor having a rotating-field, wherein a sonotrode for machining material is rotatable by means of the permanent magnet motor.

### CROSS-REFERENCE TO OTHER APPLICATIONS

This application claims the benefit of European Patent Applications No. EP 09177535 and EP 09177534, both filed on Nov. 30, 2009, the entire disclosures of which are herein incorporated.

### FIELD OF THE INVENTION

The present invention relates to a machine tool, a machine tool apparatus and a method for operating a machine tool apparatus.

### BACKGROUND OF THE INVENTION

In particular, cutting of thin and/or soft materials, e.g. plastics, by means of a sonotrode having a straight blade to which ultrasound is applied is commonly known. The ultrasound has the effect that the cutting forces are substantially reduced when compared to a blade that is only moved in the direction of cutting. The reduced cutting forces help preventing the material from moving and puckering. Depending on how a specific cut is to be made, it may be necessary to rotate the blade about its longitudinal axis, as for example described in EP 0 820 841 B1.

Different applications require different sonotrodes. Beside the sonotrodes described previously, also sonotrodes having a circular blade are available. While cutting, the circular blade is rotated at high speeds. In this way, high cutting speeds can be achieved.

No machine tool is currently available that allows the use of sonotrodes having a straight blade as well as sonotrodes having a circular blade in a simple manner.

### SUMMARY OF THE INVENTION

Accordingly, a machine tool is provided, the machine tool comprising a permanent-magnet motor having a rotating-field, wherein a sonotrode for machining material is rotatable by means of the permanent magnet motor.

Further, a machine tool apparatus is provided, the machine tool apparatus comprising a machine tool according to the invention and a sonotrode.

Further, a method for operating a machine tool apparatus, in particular a machine tool apparatus according to the invention, is provided, the method comprising the following steps: rotating a first sonotrode having a blade extending along an axis about an angle between 0 and 360 degrees about the axis by means of a permanent-magnet motor having a rotating field; moving the first sonotrode in a plane substantially perpendicular to the axis to cut material, wherein ultrasound is applied to the first sonotrode along the axis; replacing the first sonotrode by a second sonotrode having a circular blade extending substantially in the plane; and moving the second sonotrode in the plane or any other plane to cut the material or other material, wherein the second sonotrode is rotated about the axis about an angle being a multiple of 360 degrees by means of the permanent-magnet motor.

One idea of the present invention lies in realizing that a permanent-magnet motor having a rotating field can be used in two different ways: On the one hand, the permanent-magnet motor can be used to exactly position a sonotrode having a straight blade with respect to the material that is to be cut, for example within a 10^{th} of a degree, and to hold this position while cutting. On the other hand, the permanent-magnet motor can be used to rotate the sonotrode having a circular blade at a high speed, for example at approximately 500 to 1000 rounds per minute.

Thus, the present invention provides a machine tool that is more versatile. Specifically, the machine tool can be used with sonotrodes having a straight blade as well as those having a circular blade.

Presently, a “sonotrode” refers to a tool which, by inducing high frequency mechanical waves (ultrasound) into the tool, is caused to resonate. The sonotrode provides the connection between the transducer and the work piece and adjusts the ultrasound to the task at hand.

Presently, a “machine tool” refers to any type of machine that is configured to provide relative movement between the device for ultrasonic machining and the work piece.

Presently, the terms “straight blade” and “circular blade” have been used only to promote understanding. And typically, circular blades are being rotated to improve cutting, and straight blades are not. However, there may also be blades that are not rotated to improve cutting, yet have a circular shape. These blades shall be included by the term “straight blade” as used herein.

According to a preferred embodiment of the machine tool of the present invention the sonotrode is directly connectable to the permanent-magnet motor. “Directly” presently refers to no gearbox or the like being present between the permanent-magnet motor and the sonotrode. This can ensure that the sonotrode can be operated without play for a long time.

According to a preferred embodiment of the machine tool of the present invention the permanent-magnet motor is a torque motor. “torque motor” refers to a permanent-magnet motor that delivers a high torque. Torque motors require little space in their longitudinal direction, i.e. along the drive axis.

According to a preferred embodiment of the machine tool of the present invention a control device is provided, the control device being configured to control the permanent-magnet motor for rotating the sonotrode, in a first mode, about an angle between 0 and 360 degrees and, in a second mode, about an angle being a multiple of 360 degrees. When, for example, the machine tool is used together with a sonotrode having a straight blade, the control device is in the first mode. However, when the machine tool is used together with a sonotrode having a circular blade, the control device is in the second mode.

### BRIEF DESCRIPTION OF THE DRAWINGS

The invention is further described by way of example with reference to the accompanying figures.

FIG. 1 is a section view of a part of a machine tool apparatus according to a preferred embodiment of the present invention, wherein the sonotrode has a straight blade; and

FIG. 2 is a partial view of the machine tool apparatus from FIG. 1, however, with a sonotrode having a circular blade.

In the figures, the same reference numbers refer to the same or functionally equivalent components unless stated otherwise.

### DETAILED DESCRIPTION OF THE DRAWINGS

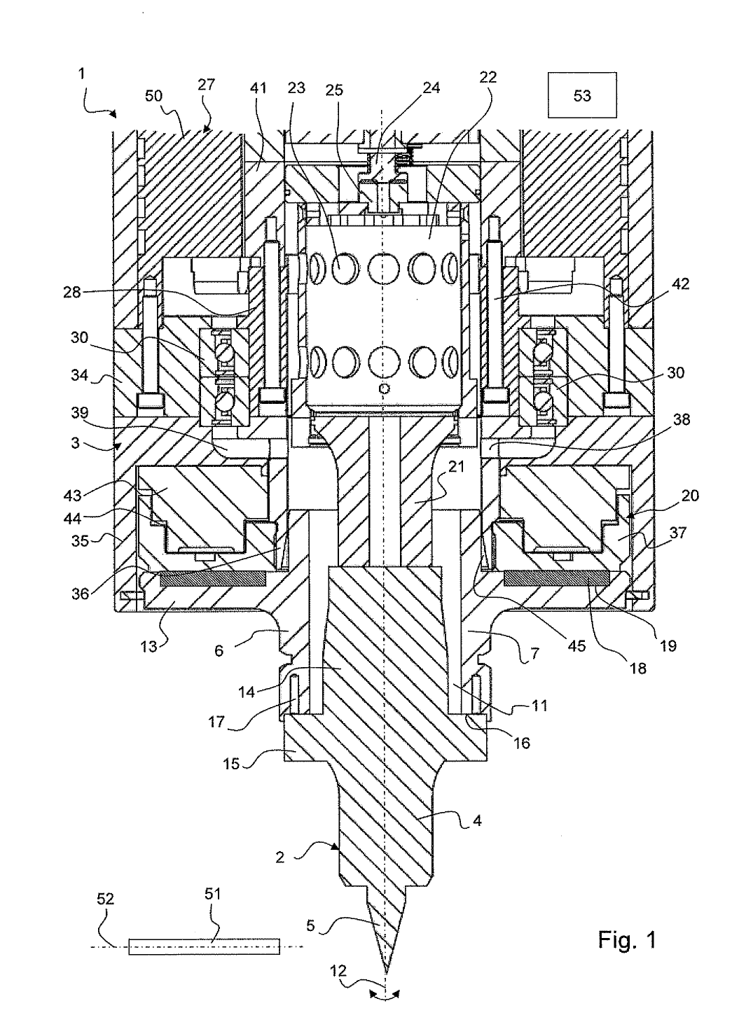

FIG. 1 is a section view of a part of a machine tool apparatus 1 according to a preferred embodiment of the invention.

The machine tool apparatus 1 is comprised of a device for ultrasonic machining 2 and a machine tool 3, wherein the latter is only shown partially.

The device for ultrasonic machining 2 comprises a sonotrode 4, which has a blade 5 for cutting plastics, for example.

The device for ultrasonic machining 2 further comprises a mounting 6. The mounting 6 comprises a portion 7 in the shape of a bushing, the portion 7 having a through-hole 11. A flange 13 extending radially with respect to the longitudinal axis 12 of the sonotrode 4 connects to the portion 7.

The sonotrode 4 has a first portion 14 extending upwards into the through-hole 11 and has a second portion 15 extending downwards and outside the through-hole 11, the second portion 15 being flanged to a lower face 16 of the portion 7 of the mounting 6, for example by means of screws 17. The second portion 15 of the sonotrode 4 carries the blade 5 at its lower end.

An armature 18 is fixedly connected to the flange 13 of the mounting 6. The armature can be made from steel and, preferably, has a ring shape. The armature 18 is set into a recess 19 in the upper side of the flange 13. The armature 18 is configured to interact with a device for magnetizing 20 of the machine tool 3—which is described in more detail at a later stage—to release the device for ultrasonic machining 2 from the machine tool 3 or to fixedly connect the device for ultrasonic machining 2 to the machine tool 3. FIG. 1 shows the device for ultrasonic machining 2 and the machine tool 3 in the fixedly connected state.

A coupling piece 21 of the device for ultrasonic machining 2 connects to the first portion 14 of the sonotrode 4 and extends upwardly therefrom. The coupling piece 21 connects a transducer 22 of the device for ultrasonic machining 2 to the sonotrode 4.

The transducer 22 may comprise a plurality of openings for cooling 23. The transducer 22 is only connected to the machine tool 3 via a pin 24 at its upper end, the pin 24 being movably along the longitudinal axis 12. The pin 24 is urged by means of a spring (not shown) along the longitudinal axis 12 against a contact element 25 of the transducer 22. Electrical energy is transferred from the machine tool 3 to the transducer 22 via the pin 24 and the contact elements 25. The transducer 22 converts the electrical energy into ultrasonic waves and transmits the waves to the sonotrode 4 via the coupling element 21. The resulting oscillation of the blade 5 along the longitudinal axis 12 helps cutting more easily through plastics, for example.

The transducer 22 and the coupling element 21 extend upwardly into the machine tool 3. In particular, these components may extend through a hollow shaft 26 of the machine tool 3. The hollow shaft 26 connects an electric motor 27 of the machine tool 3 to a rotor 37 of the device for magnetizing 20 in a rotationally locked manner. Preferably, the hollow shaft 26 is comprised of portions 28 and 29 fixedly connected to each other.

The portions 28 and 29 of the hollow shaft 26 may be supported, for example by means of ball bearings 30, in housing portions 34 and 35 of the machine tool 3. The portion 28 of the hollow shaft 26 is preferably fixedly connected to a rotor 41 of the electric motor 27, for example by means of bolts 42. The portion 29 of the hollow shaft 26 may be fixedly connected to the rotor 37 at its lower end substantially opposite the portion 28. The portion 7 of the mounting 6 of the device for ultrasonic machining 2 may extend into the lower end 36 of the portion 29 of the hollow shaft 26. The lower end 36 of the portion 29 preferably has a chamfer 45 to assist when inserting the portion 7 of the mounting 6 into the lower end 36. Further, the portion 29 may comprise radial openings 38 that are connected to channels 39 to ventilate the ball bearings 30.

Beside the rotor 37, which has a ring shape and is, for example, made of steel, the device for magnetizing 20 has a coil 43. The coil 43 is fixedly connected to the housing portion 35 and therefore stationary with respect to the rotor 37. In the state shown in FIG. 1 where a current passes through the coil 43, the coil 43 generates a magnetic field passing through the rotor 37 as well as the armature 18 of the device for ultrasonic machining 2. The magnetic coupling between the coil 43 as well as the rotor 37 and the armature 18 is further increased due to the coil 43 partially extending into the rotor 37. To this end, a gap 44 in a labyrinth shape is formed between the coil 43 and the rotor 37.

The magnetic field results in the armature 18 being locked to the rotor 37. This locking is well suited to transmit high torques between the electric motor 27 and the sonotrode 4.

When the power supply to the coil 43 is disconnected, the lock between the rotor 37 and the armature 18 is released and the device for ultrasonic machining 2 may be replaced by another device for ultrasonic machining suited to the new task at hand.

Hereinafter, the operating principle of the permanent-magnet motor 27 is explained in more detail.

The permanent-magnet motor 27 also has a stator 50 surrounding the rotor 41. The permanent-magnet motor 27 is configured to rotate the device for ultrasonic machining 2 about its longitudinal axis 12. Preferably, the permanent-magnet motor 27 is a “torque motor”. The rotation of the permanent-magnet motor 27 can be carried out in two different ways:

If a sonotrode 4, see FIG. 1, having a blade 5, i.e. a blade that is not rotated to thereby improve a cutting action, is used, certain applications may require positioning of the blade 5 with respect to the material 51 that is to be cut. This again may require rotating the blade 5 from its current position by an angle between 0 and 360 degrees about its longitudinal axis 12 to a target position, this being indicated in FIG. 1 by a double arrow. To this end, a control unit 53 of the machine tool 3—shown only schematically in FIG. 1—controls the permanent-magnet motor 27 to rotate the blade 5 to the target position. According to the present embodiment, the entire device for ultrasonic machining 2 rotates about the longitudinal axis 12. However, this is optional as only the sonotrode 4 may be rotated in some devices. After rotation the blade 5 is moved in a plane 52 substantially perpendicular to the longitudinal axis 12 to cut the material 51 by moving the machine tool apparatus 1.

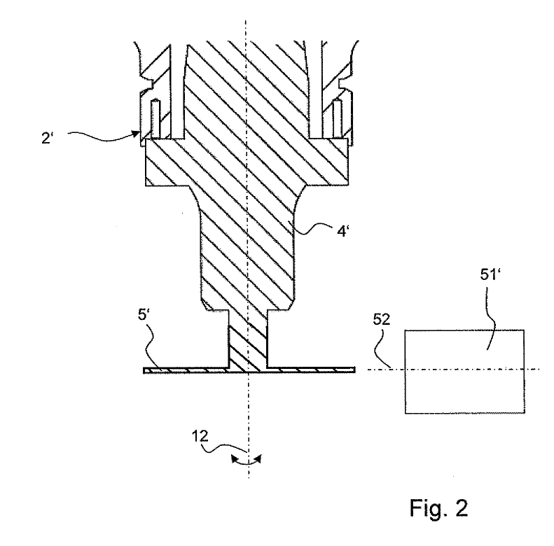

Now, with reference to FIG. 2 the rotation of the second type is explained.

A new machining task may require replacing the device for ultrasonic machining 2 (or merely the sonotrode 4 having the blade 5) by another device for ultrasonic machining 2′ (or merely another sonotrode 4′ having a circular blade 5′) shown in FIG. 2. This replacement can be done in the way described earlier, i.e. interrupting the power supply to the coil 43 etc.

The device for ultrasonic machining 2′ differs from the device for ultrasonic machining 2 shown in FIG. 1 in the former comprising a sonotrode 4′ having a circular blade 5′. The circular blade 5′ has a circular shape when seen in plan view (not shown). The circular blade 5′ substantially extends in the plane 52 perpendicular to the longitudinal axis 12.

The circular blade 5′ needs to be rotated at a high speed, for example at 500 to 1000 rotations per minute, about the longitudinal axis 12, this being indicated by a double arrow in FIG. 2. This is also achieved by means of the permanent-magnet motor 27 which is controlled accordingly by the control device 53. Then, the rotating circular blade 5′ is moved in the plane 52 substantially perpendicular to the longitudinal axis 12 to cut the material by means of moving the machine tool apparatus 1.

Although the present invention has been described with reference to preferred embodiments, it is not restricted thereto but rather can be modified in many ways. The terms “upper” and “lower” have only been used herein to ensure a good understanding of the positions of the components with respect to one another. However, this is not to be construed as a restriction with regard to their positions in absolute terms; when looking at the figures in landscape, the terms “left” and “right” could have been used just as well to describe them.

Further, the embodiments of the machine tool described herein may just as well be applied to the machine tool apparatus according to the invention or the method according to the invention, and vice versa.

What is claimed is:

1. Machine tool, comprising a permanent-magnet motor having a rotating-field, wherein a sonotrode for machining material is rotatable by means of the permanent-magnet motor.

2. Machine tool according to claim 1, wherein the sonotrode is directly connectable to the permanent-magnet motor.

3. Machine tool according to claim 1, wherein the permanent-magnet motor is a torque motor.

4. Machine tool according to claim 1, wherein a control device is provided, the control device being configured to control the permanent-magnet motor for rotating the sonotrode, in a first mode, about an angle between 0 and 360 degrees and, in a second mode, for rotating another sonotrode about an angle being a multiple of 360 degrees.

5. Machine tool apparatus, comprising a machine tool according to claim 1 and a sonotrode.

6. Method for operating a machine tool apparatus, in particular a machine tool apparatus according to claim 5, the method comprising the following steps:
Rotating a first sonotrode having a blade extending along an axis about an angle between 0 and 360 degrees about the axis by means of a permanent-magnet motor having a rotating field;
Moving the first sonotrode in a plane substantially perpendicular to the axis to cut material, wherein ultrasound is applied to the first sonotrode along the axis;
Replacing the first sonotrode by a second sonotrode having a circular blade extending substantially in the plane;
Moving the second sonotrode in the plane or any other plane to cut the material or other material, wherein the second sonotrode is rotated about the axis about an angle being a multiple of 360 degrees by means of the permanent-magnet motor.
